(19) United States
(12) Patent Application Publication
(10) Pub. No.: US 2024/0378086 A1
(43) Pub. Date: Nov. 14, 2024

(54) DATA RECOVERY METHOD, SYSTEM AND APPARATUS AND STORAGE DEVICE

(71) Applicant: SUZHOU METABRAIN INTELLIGENT TECHNOLOGY CO., LTD., Suzhou, Jiangsu (CN)

(72) Inventors: Sirun WANG, Suzhou, Jiangsu (CN); Ji ZHONG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/574,609

(22) PCT Filed: Sep. 28, 2022
(86) PCT No.: PCT/CN2022/122301

§ 371 Date: Dec. 27, 2023

(30) Foreign Application Priority Data
Feb. 18, 2022 (CN) 202210148488.7

(51) Int. Cl. G06F 9/50; G06F 11/14

(52) U.S. Cl. CPC G06F 9/5027; G06F 11/1469; G06F 2201/84

(57) ABSTRACT

Provided are a data recovery method, system and apparatus and a storage device. In the present disclosure, a data volume of metadata of each type is acquired; a corresponding quantity of CPUs are allocated to the metadata of each type according to the data volume thereof; and when the storage device is powered on, each CPU is controlled to recover the metadata of the type corresponding thereto. In the present disclosure, by means of acquiring the data volume of the metadata of each type and allocating different numbers of CPUs to the metadata according to different data volumes thereof, when the storage device is powered on and the metadata in the storage device needs to be recovered, multiple CPUs are controlled to recover the metadata of the types corresponding thereto, so that the metadata recovery efficiency and speed may be improved.

### CROSS-REFERENCE TO RELATED APPLICATIONS

The present application is a National Stage Application of PCT International Application No.: PCT/CN2022/122301 filed on Sep. 28, 2022, which claims priority to Chinese Patent Application 202210148488.7, filed in the China National Intellectual Property Administration on Feb. 18, 2022, the disclosure of which is incorporated herein by reference in its entirety.

### TECHNICAL FIELD

The present disclosure relates to the field of data storage, and in particular to a data recovery method, system and apparatus and a storage device.

### BACKGROUND

A Solid State Disk (SSD) uses an NAND (NAND flash memory, computer flash memory device) as a storage medium. When data needs to be written, the SSD receives data first, then writes the received data to the NAND, and modifies metadata at the same time, and a data storage module saves the metadata in the NAND. After the device is powered off and powered on again, a Central Processing Unit (CPU) needs to read the metadata from the NAND, and the data storage module performs data recovery on the metadata before ensuring the normal use of the device. Therefore, it is necessary to provide a fast and reliable data method.

### SUMMARY

The present disclosure aims to provide a data recovery method, system and apparatus and a storage device. By means of acquiring a data volume of metadata of each type and allocating different numbers of CPUs to the metadata according to different data volumes thereof, when the storage device is powered on and the metadata in the storage device needs to be recovered, multiple CPUs are controlled to recover the metadata of the types corresponding thereto, so that the metadata recovery efficiency and speed may be improved.

In order to solve the above technical problem, the present disclosure provides a data recovery method, applied to a storage device in which multiple types of metadata are stored. The method includes the following operations.

A data volume of the metadata of each type is acquired.

A corresponding quantity of CPUs are allocated to the metadata of each type according to the data volume thereof.

When the storage device is powered on, each CPU is controlled to recover the metadata of the type corresponding thereto.

In an embodiment, the operation that the corresponding quantity of CPUs are allocated to the metadata of each type according to the data volume thereof includes the following operations.

It is determined whether the data volume of the metadata of each type is greater than a preset data volume.

If the data volume of the metadata of each type is greater than the preset data volume, M CPUs are allocated to the metadata of the type with the data volume greater than the preset data volume, and N CPUs are allocated to the metadata of all the types with the data volume not greater than the preset data volume. M and N are both integers not less than 1.

In an embodiment, after the data volume of the metadata of each type is acquired, the method further includes the following operation.

The type of the metadata with the largest data volume is determined and set as a preset type.

The operation that the corresponding quantity of CPUs are allocated to the metadata of each type according to the data volume thereof includes the following operation.

M CPUs are allocated to the metadata of the preset type, and N CPUs are allocated to the metadata of the types other than the preset type. M and N are both integers not less than 1.

In an embodiment, the preset type is a Logical To Physical (L2P) type, M is 2, and N is 1.

The operation that each CPU is controlled to recover the metadata of the type corresponding thereto includes the following operations.

The first CPU is controlled to recover all the metadata other than the metadata of the L2P type.

The second CPU is controlled to recover base data of the L2P type.

The third CPU is controlled to recover delta data of the L2P type.

In an embodiment, the operation that each CPU is controlled to recover the metadata of the type corresponding thereto includes the following operations.

The first CPU is controlled to recover a primary table and a secondary table.

After the primary table and the secondary table are recovered, the first CPU is controlled to recover the metadata other than the data of the primary table, the secondary table and the L2P type based on the primary table and the secondary table, and a first message is sent to the second CPU to start the second CPU.

The second CPU is controlled to recover the base data based on the primary table and the secondary table.

After the base data is recovered, a second message is sent to the third CPU to start the third CPU.

The third CPU is controlled to recover the delta data based on the primary table and the secondary table.

In an embodiment, the metadata of the L2P type includes multiple sets of base data and multiple sets of delta data in one-to-one correspondence with multiple sets of base data.

The operation that the second CPU is controlled to recover the base data based on the primary table and the secondary table includes the following operation.

The second CPU is controlled to recover the first set of base data based on the primary table and the secondary table, and after the first set of delta data is recovered, the second CPU is controlled to recover the second set of base data; and after the second set of delta data is recovered, the second CPU is controlled to recover the third set of base data until the second CPU recovers all the sets of base data.

The operation that the third CPU is controlled to recover the delta data based on the primary table and the secondary table includes the following operation.

After the first set of base data is recovered, the third CPU is controlled to recover the first set of delta data based on the primary table and the secondary table, and after the second set of base data is recovered, the third CPU is controlled to recover the second set of delta data until the third CPU recovers all the sets of delta data.

In an embodiment, after the third CPU recovers all the sets of delta data, the method further includes the following operations.

The first CPU is controlled to detect whether the recovery of all the metadata is completed.

If the first CPU is controlled to detect that the recovery of all the metadata is completed, a data recovery completion instruction is sent to prompt a user.

In order to solve the above technical problem, the present disclosure further provides a data recovery system, applied to a storage device in which multiple types of metadata are stored. The system includes an acquisition unit, an allocation unit and a recovery unit.

The acquisition unit is configured to acquire a data volume of the metadata of each type.

The allocation unit is configured to allocate a corresponding quantity of CPUs to the metadata of each type according to the data volume thereof.

The recovery unit is configured to control, when the storage device is powered on, each CPU to recover the metadata of the type corresponding thereto.

In order to solve the above technical problem, the present disclosure further provides a data recovery apparatus, which includes a memory and a processor.

The memory is configured to store a computer program.

The processor is configured to implement steps of the above data recovery method when executing the computer program.

In order to solve the above technical problem, the present disclosure further provides a storage device, which includes multiple CPUs and the above data recovery apparatus.

The present disclosure provides the data recovery method, system and apparatus and the storage device. In the present solution, the data volume of the metadata of each type is acquired; the corresponding quantity of CPUs are allocated to the metadata of each type according to the data volume thereof; and when the storage device is powered on, each CPU is controlled to recover the metadata of the type corresponding thereto. In the present disclosure, by means of acquiring the data volume of the metadata of each type and allocating different numbers of CPUs to the metadata according to different data volumes thereof, when the storage device is powered on and the metadata in the storage device needs to be recovered, multiple CPUs are controlled to recover the metadata of the types corresponding thereto, so that the metadata recovery efficiency and speed may be improved.

### BRIEF DESCRIPTION OF THE DRAWINGS

In order to more clearly illustrate the technical solutions in the embodiments of the present disclosure, the drawings used in the related art and the embodiments will be briefly described below. It is apparent that the drawings described below are only some embodiments of the present disclosure. Other drawings may further be obtained by those of ordinary skill in the art according to these drawings without creative efforts.

FIG. 1 is a flowchart of a data recovery method provided by the present disclosure.

FIG. 2 is a structural block diagram of a data recovery system provided by the present disclosure.

FIG. 3 is a structural block diagram of a data recovery apparatus provided by the present disclosure.

### DETAILED DESCRIPTION OF THE EMBODIMENTS

The core of the present disclosure is to provide a data recovery method, system and apparatus and a storage device. By means of acquiring a data volume of metadata of each type and allocating different numbers of CPUs to the metadata according to different data volumes thereof, when the storage device is powered on and the metadata in the storage device needs to be recovered, multiple CPUs are controlled to recover the metadata of the types corresponding thereto, so that the metadata recovery efficiency and speed may be improved.

In order to make the objects, technical solutions and advantages of the embodiments of the present disclosure clearer, the technical solutions in the embodiments of the present disclosure will be clearly and completely described in conjunction with the drawings in the embodiments of the present disclosure. It is apparent that the described embodiments are only a part of the embodiments of the present disclosure, and not all of them. All other embodiments obtained by those of ordinary skill in the art based on the embodiments of the present disclosure without creative efforts are within the scope of protection of the present disclosure.

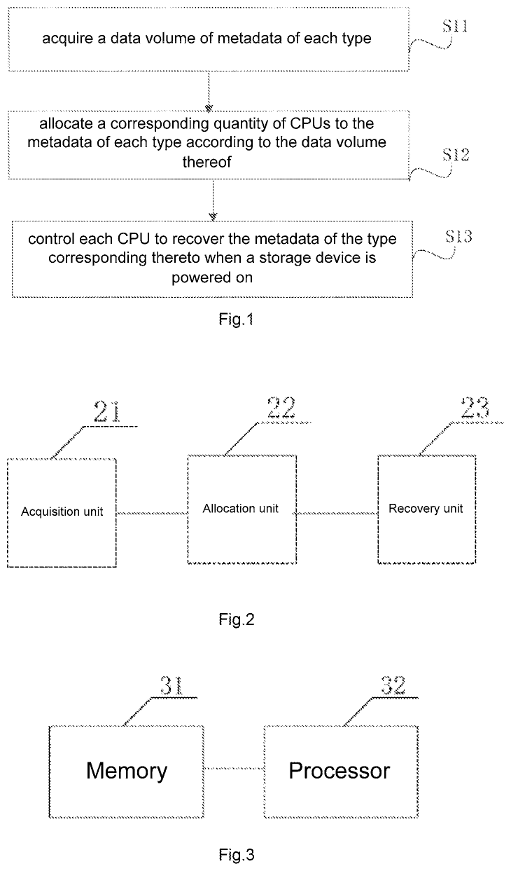

Referring to FIG. 1, FIG. 1 is a flowchart of a data recovery method provided by the present disclosure. The method is applied to a storage device in which multiple types of metadata are stored. The method includes the following operations.

At S11, a data volume of the metadata of each type is acquired.

In an embodiment, considering the large data volume of all the metadata stored in the storage device, the speed is slow when performing data recovery on the metadata by directly using one CPU. Therefore, in the present disclosure, by means of classifying the stored metadata, and then respectively arranging different numbers of CPUs, the batch recovery of the metadata is implemented to improve the metadata recovery speed and efficiency.

In an embodiment, a specific implementation of classifying the metadata in the present disclosure is: taking the data volumes of different types of the metadata as a classification standard. Therefore, the first step to be performed in the present disclosure is to acquire the data volume of the metadata of each type.

It is to be noted that this step may be performed when the storage device is not powered off, for example, the data volume of the metadata of each type stored in the storage device is stored in a certain unit or a certain module, and related data of the data volume stored in this unit or module is read after the storage device is powered on again.

The above are only some specific implementations of the present disclosure, and may also be other implementations, which will not be limited herein.

At S12, a corresponding quantity of CPUs are allocated to the metadata of each type according to the data volume thereof.

In an embodiment, after the data volume of the metadata of each type has been acquired, further, different numbers of CPUs are allocated to the metadata according to a correspondence between the data volume and the quantity of CPUs, thereby reducing the pressure of recovering the metadata by each CPU and improving the speed of recovering all the metadata.

The specific manner of allocating the quantity of CPUs may be as follows: for the type of the metadata with the larger data volume, the more CPUs are allocated, or the CPU with the fast processing speed is allocated, and for the type of the metadata with the small data volume, the fewer CPUs are allocated, or the CPU with the relatively slow processing speed is allocated. For the type of the metadata with the very small data volume, multiple types of metadata may share one CPU, etc.

After the quantity of CPUs allocated to the metadata of each type is determined, the corresponding quantity of CPUs are allocated to the metadata correspondingly, and the specific allocation manner will not be limited in the present disclosure.

At S13, when the storage device is powered on, each CPU is controlled to recover the metadata of the type corresponding thereto.

In an embodiment, when the storage device is powered off and powered on again, each CPU is controlled to recover the metadata of the type corresponding thereto to ensure that all the metadata may be recovered.

In summary, in the present disclosure, by means of acquiring the data volume of the metadata of each type and allocating different numbers of CPUs to the metadata according to different data volumes thereof, when the storage device is powered on and the metadata in the storage device needs to be recovered, multiple CPUs are controlled to recover the metadata of the types corresponding thereto, so that the metadata recovery efficiency and speed may be improved.

On the basis of the above embodiment:

As an exemplary embodiment, the operation that the corresponding quantity of CPUs are allocated to the metadata of each type according to the data volume thereof includes the following operations.

It is determined whether the data volume of the metadata of each type is greater than a preset data volume.

If the data volume of the metadata of each type is greater than the preset data volume, M CPUs are allocated to the metadata of the type with the data volume greater than the preset data volume, and N CPUs are allocated to the metadata of all the types with the data volume not greater than the preset data volume. M and N are both integers not less than 1.

The embodiment is intended to define a specific implementation of allocating the CPUs, which may be, but is not limited to, achieved by means of comparing the data volume of the metadata of each type with the preset data volume, and then determining that the data volume of the metadata of the type with the data volume greater than the preset data volume is relatively large, so that the M CPUs are arranged separately for them, where M may be one or more according to actual requirements. The metadata of the type with the data volume not greater than the preset data volume, which is determined to have a relatively small data volume, may be used as an aggregation, and then N pieces of metadata are allocated in a unified manner. When the data volume is small, N may be 1, and when the data volume is relatively large, N may be an integer greater than 1.

The specific values of the preset data volume, M and N are determined according to the actual situation, and will not be limited herein.

It can be seen that by means of the manner in the embodiment, the function of allocating different numbers of CPUs to the metadata may be achieved, and the implementation is simple and reliable.

As an exemplary embodiment, after the data volume of the metadata of each type is acquired, the method further includes the following operation.

The type of the metadata with the largest data volume is determined and set as a preset type.

The operation that the corresponding quantity of CPUs are allocated to the metadata of each type according to the data volume thereof includes the following operation.

M CPUs are allocated to the metadata of the preset type, and N CPUs are allocated to the metadata of the types other than the preset type. M and N are both integers not less than 1.

The embodiment is intended to define another specific implementation of allocating the CPUs, which may be, but is not limited to, achieved by means of selecting the metadata of the type with the largest data volume through the data volume of the metadata of each type, and then allocating the M CPUs thereto, where M may be 1 or set to more than one according to actual requirements. The metadata of other types, which is determined to have a relatively small data volume, may be used as an aggregation, and then N pieces of metadata are allocated in a unified manner. When the data volume is small, N may be 1, and when the data volume is relatively large, N may be an integer greater than 1.

The specific values of M and N are determined according to the actual situation, and will not be limited herein.

It can be seen that by means of the manner in the embodiment, the quantity of CPUs may be limited to a certain extent, the excessive quantity of CPUs used is avoided, the cost of the storage device may be reduced, the function of allocating different numbers of CPUs to the metadata may be achieved, and the implementation is simple and reliable.

As an exemplary embodiment, the preset type is an L2P type, M is 2, and N is 1.

The operation that each CPU is controlled to recover the metadata of the type corresponding thereto includes the following operations.

The first CPU is controlled to recover all the metadata other than the metadata of the L2P type.

The second CPU is controlled to recover base data of the L2P type.

The third CPU is controlled to recover delta data of the L2P type.

In an embodiment, considering that the type of the metadata with the largest data volume stored in the storage device is the L2P type, two CPUs are arranged for the metadata of the L2P type, one is responsible for recovering the base data of the L2P type, the other is responsible for recovering the delta data of the L2P type, and then one CPU is allocated to other metadata, so that the speed of recovering all the metadata is improved and the workload of each CPU is reduced.

As an exemplary embodiment, the operation that each CPU is controlled to recover the metadata of the type corresponding thereto includes the following operations.

The first CPU is controlled to recover a primary table and a secondary table.

After the primary table and the secondary table are recovered, the first CPU is controlled to recover the metadata other than the data of the primary table, the secondary table and the L2P type based on the primary table and the secondary table, and a first message is sent to the second CPU to start the second CPU.

The second CPU is controlled to recover the base data based on the primary table and the secondary table.

After the base data is recovered, a second message is sent to the third CPU to start the third CPU.

The third CPU is controlled to recover the delta data based on the primary table and the secondary table.

In an embodiment, when processing other metadata, the first CPU needs to recover the primary table and secondary table first, and then the second and third CPU may recover the base data and the delta data of the L2P type based on the primary table and secondary table. The primary table is a correspondence between the metadata and an address, the secondary table is a correspondence between the primary table and the address, and only after the primary table and the secondary table are recovered, the second CPU and the third CPU may work normally.

In an embodiment, after recovering the primary table and secondary table, the first CPU sends the first message to the second CPU, and the second CPU starts to recover the base data. At the same time, the first CPU begins to recover the metadata other than the L2P type, and works synchronously with the second CPU or the third CPU. After recovering the base data, the second CPU sends the second message to the third CPU, and the third CPU starts to recover the delta data.

It can be seen that there is a moment when the first CPU works synchronously with the second CPU or the third CPU, which may improve the metadata recovery speed to a certain extent. The three CPUs communicate with each other by means of transmitting message instructions, which may ensure the orderliness and rationality of the work among the three CPUs.

As an exemplary embodiment, the metadata of the L2P type includes multiple sets of base data and multiple sets of delta data in one-to-one correspondence with multiple sets of base data.

The operation that the second CPU is controlled to recover the base data based on the primary table and the secondary table includes the following operation.

The second CPU is controlled to recover the first set of base data based on the primary table and the secondary table, and after the first set of delta data is recovered, the second CPU is controlled to recover the second set of base data; and after the second set of delta data is recovered, the second CPU is controlled to recover the third set of base data until the second CPU recovers all the sets of base data.

The operation that the third CPU is controlled to recover the delta data based on the primary table and the secondary table includes the following operation.

After the first set of base data is recovered, the third CPU is controlled to recover the first set of delta data based on the primary table and the secondary table, and after the second set of base data is recovered, the third CPU is controlled to recover the second set of delta data until the third CPU recovers all the sets of delta data.

In an embodiment, when multiple sets of base data and delta data are included and in one-to-one correspondence, the specific steps of recovering the data are as follows: the first set of base data and the first set of delta data are recovered first, and then the second set of base data and the second set of delta data are recovered until the last set of base data and the last set of delta data are recovered. Between each set of base data and each set of delta data, the base data is recovered first, and then the delta data is recovered.

In summary, the total data recovery process is as follows: the first CPU recovers the primary table and the secondary table, and then the first CPU recovers other metadata other than the L2P type; the second CPU recovers the first set of base data, and the third CPU recovers the first set of delta data; and the second CPU recovers the second set of base data, and the third CPU recovers the second set of delta data until the second CPU recovers the last set of base data, and the third CPU recovers the last set of delta data.

It can be seen that by means of the manner in the present disclosure, the recovery of all the metadata may be achieved, the recovery of multiple sets of base data and delta data may also be achieved, and the recovery steps are reliable and orderly.

As an exemplary embodiment, after the third CPU recovers all the sets of delta data, the method further includes the following operations.

The first CPU is controlled to detect whether the recovery of all the metadata is completed.

If the first CPU is controlled to detect that the recovery of all the metadata is completed, a data recovery completion instruction is sent to prompt a user.

In an embodiment, after the last set of delta data is recovered, the first CPU detects whether the recovery of all the metadata is completed. If the first CPU is controlled to detect that the recovery of all the metadata is completed, the recovery is completed, otherwise it is determined that the recovery is not completed.

In an embodiment, each time the recovery of a set of data is completed, a control bit of the corresponding data may be set to 1, and then it is detected whether the recovery of all the metadata is completed. It may be detected whether all the control bits are in a state of being set to 1, if so, it is determined that the recovery of all the metadata is completed, and if not, it is determined that the recovery of all the metadata is not yet completed. After detecting that the recovery of all the metadata is completed, a prompter message may be sent to the user.

It can be seen that by means of the manner in the present disclosure, the detection of whether the recovery of the metadata is completed may be achieved to ensure the reliability of the recovery of the metadata.

Referring to FIG. 2, FIG. 2 is a flowchart of a data recovery system provided by the present disclosure. The system is applied to a storage device in which multiple types of metadata are stored. The system includes an acquisition unit 21, an allocation unit 22 and a recovery unit 23.

The acquisition unit 21 is configured to acquire a data volume of the metadata of each type.

The allocation unit 22 is configured to allocate a corresponding quantity of CPUs to the metadata of each type according to the data volume thereof.

The recovery unit 23 is configured to control, when the storage device is powered on, each CPU to recover the metadata of the type corresponding thereto.

In order to solve the above technical problem, the present disclosure further provides a data recovery system. The description of the data recovery system refers to the above embodiment, which will not be elaborated herein.

Referring to FIG. 3, FIG. 3 is a structural block diagram of a data recovery apparatus provided by the present disclosure. The apparatus includes a memory 31 and a processor 32.

The memory 31 is configured to store a computer program.

The processor 32 is configured to implement steps of the above data recovery method when executing the computer program.

In order to solve the above technical problem, the present disclosure further provides a data recovery apparatus. The description of the data recovery apparatus refers to the above embodiment, which will not be elaborated herein.

A storage device includes multiple CPUs and the above data recovery apparatus.

In order to solve the above technical problem, the present disclosure further provides a storage apparatus. The description of the storage device refers to the above embodiment, which will not be elaborated herein.

It is to be noted that relational terms “first”, “second” and the like herein are adopted only to distinguish one entity or operation from another entity or operation and not always to require or imply existence of any such practical relationship or sequence between the entities or operations. Furthermore, terms “include” and “contain” or any other variant thereof is intended to cover nonexclusive inclusions herein, so that a process, method, object or device including a series of elements not only includes those elements but also includes other elements which are not clearly listed or further includes elements intrinsic to the process, the method, the object or the device. Under the condition of no more limitations, an element defined by the statement “including a/an . . . ” does not exclude existence of the same other elements in a process, method, object or device including the element.

Professionals may realize that the units and algorithm steps of each example described in combination with the embodiments disclosed in the present disclosure may be implemented by electronic hardware, computer hardware or a combination of computer software and the electronic hardware. In order to clearly illustrate the interchangeability of hardware and software, the composition and steps of each example have been described in general terms of function in the above description. Whether these functions are executed in a hardware or software manner depends on specific applications and design constraints of the technical solutions. Professionals may realize the described functions for each specific application by use of different methods, but such realization shall fall within the scope of the present disclosure.

The above description of the disclosed embodiments enables those skilled in the art to implement or use the present disclosure. Various modifications to these embodiments will be apparent to those skilled in the art, and the general principles defined herein may be implemented in other embodiments without departing from the spirit or scope of the present disclosure. Therefore, the present disclosure will not be limited to the embodiments shown herein, but is within the widest scope consistent with the principles and novel features disclosed herein.

1. A data recovery method, applied to a storage device in which multiple types of metadata are stored, the method comprising:
acquiring a data volume of metadata of each type;
allocating a corresponding quantity of Central Processing Units (CPUs) to the metadata of each type according to the data volume of metadata of each type; and
when the storage device is powered on, controlling each CPU to recover the metadata of the type corresponding to each CPU.

2. The data recovery method according to claim 1, wherein the storage device comprises at least one storage unit; acquiring a data volume of metadata of each type comprises:
when the storage device is powered on, acquiring the data volume of the metadata from the storage unit according to different types.

3. The data recovery method according to claim 1, wherein allocating a corresponding quantity of CPUs to the metadata of each type according to the data volume of metadata of each type comprises:
acquiring a quantity mapping relationship between the data volume of the metadata and the CPU; and
allocating the corresponding quantity of CPUs to the metadata of each type according to the data volume thereof and the quantity mapping relationship.

4. The data recovery method according to claim 1, wherein allocating the corresponding quantity of CPUs to the metadata of each type according to the data volume thereof and the quantity mapping relationship comprises:
determining whether the data volume of the metadata of each type is greater than a preset data volume; and
when the data volume of the metadata of each type is greater than the preset data volume, allocating M CPUs to the metadata of the type with the data volume greater than the preset data volume by using the quantity mapping relationship, and allocating N CPUs to the metadata of all the types with the data volume not greater than the preset data volume, wherein M and N are both integers not less than 1.

5. The data recovery method according to claim 1, wherein allocating N CPUs to the metadata of all the types with the data volume not greater than the preset data volume comprises:
performing aggregation processing on the metadata of all the types with the data volume not greater than the preset data volume, and allocating the N CPUs to the metadata.

6. The data recovery method according to claim 1, after acquiring the data volume of the metadata of each type, further comprising:
determining the type of the metadata with the largest data volume and setting as a preset type;
allocating a corresponding quantity of CPUs to the metadata of each type according to the data volume thereof comprises:
allocating M CPUs to the metadata of the preset type, and allocating N CPUs to the metadata of the types other than the preset type, wherein M and N are both integers not less than 1.

7. The data recovery method according to claim 4, wherein M is greater than or equal to N.

8. The data recovery method according to claim 6, wherein the preset type is a Logical To Physical (L2P) type, M is 2, and N is 1;
controlling each CPU to recover the metadata of the type corresponding to each CPU comprises:
controlling the first CPU to recover all the metadata other than the metadata of the L2P type;
controlling the second CPU to recover base data of the L2P type; and
controlling the third CPU to recover delta data of the L2P type.

9. The data recovery method according to claim 8, wherein controlling each CPU to recover the metadata of the type corresponding to each CPU comprises:
controlling the first CPU to recover a primary table and a secondary table;
after the primary table and the secondary table are recovered, controlling the first CPU to recover the metadata other than the data of the primary table, the secondary table and the L2P type based on the primary table and the secondary table, and sending a first message to the second CPU to start the second CPU;
controlling the second CPU to recover the base data based on the primary table and the secondary table;
after the base data is recovered, sending a second message to the third CPU to start the third CPU; and
controlling the third CPU to recover the delta data based on the primary table and the secondary table.

10. The data recovery method according to claim 9, after the primary table and the secondary table are recovered, further comprising:
establishing a communication channel between the first CPU, the second CPU and the third CPU;
in the communication channel, the first CPU, the second CPU and the third CPU communicate by means of transmitting message instructions;
wherein the message instructions comprise the first message corresponding to the second CPU and the second message corresponding to the third CPU.

11. The data recovery method according to claim 9, wherein the primary table is generated in the following manner:
acquiring the metadata of each CPU and a data address of the metadata; and
generating the primary table by using the metadata and the data address.

12. The data recovery method according to claim 11, wherein the secondary table is generated in the following manner:
generating the secondary table by using the primary table and the data address.

13. The data recovery method according to claim 9, wherein the metadata of the L2P type comprises multiple sets of base data and multiple sets of delta data in one-to-one correspondence with multiple sets of base data;
controlling the second CPU to recover the base data based on the primary table and the secondary table comprises:
controlling the second CPU to recover the first set of base data based on the primary table and the secondary table, and after the first set of delta data is recovered, controlling the second CPU to recover the second set of base data; and after the second set of delta data is recovered, controlling the second CPU to recover the third set of base data until the second CPU recovers all the sets of base data;
controlling the third CPU to recover the delta data based on the primary table and the secondary table comprises:
after the first set of base data is recovered, controlling the third CPU to recover the first set of delta data based on the primary table and the secondary table, and after the second set of base data is recovered, controlling the third CPU to recover the second set of delta data until the third CPU recovers all the sets of delta data.

14. The data recovery method according to claim 13, after the third CPU recovers all the sets of delta data, further comprising:
controlling the first CPU to detect whether the recovery of all the metadata is completed; and
when the first CPU is controlled to detect that the recovery of all the metadata is completed, sending a data recovery completion instruction to prompt a user.

15. The data recovery method according to claim 14, wherein controlling the first CPU to detect whether the recovery of all the metadata is completed comprises:
controlling the first CPU to acquire control position information corresponding to all the metadata; and
detecting, by the first CPU, whether the recovery of all the metadata is completed according to the control position information.

16. The data recovery method according to claim 15, wherein controlling the first CPU to acquire control position information corresponding to all the metadata comprises:
generating, by the CPU after the completion of a recovery operation of a set of metadata, the control position information for the metadata until the recovery operation of all the metadata is completed, and controlling the first CPU to acquire the control position information corresponding to all the metadata.

17. The data recovery method according to claim 14, further comprising:
when the first CPU is controlled to detect that the recovery of all the metadata is not completed, generating a determination result that all the metadata is not recovered.

18. (canceled)

19. A data recovery apparatus, applied to a storage device in which multiple types of metadata are stored, comprising:
a memory, configured to store a computer program; and
a processor, configured to execute the computer program to:
acquire a data volume of metadata of each type;
allocate a corresponding quantity of Central Processing Units (CPUs) to the metadata of each type according to the data volume of metadata of each type; and
when the storage device is powered on, control each CPU to recover the metadata of the type corresponding to each CPU.

20. A storage device, comprising multiple Central Processing Units (CPUs) and a data recovery apparatus, and multiple types of metadata are stored in the storage device, wherein the data recovery apparatus comprises:
a memory, configured to store a computer program; and
a processor, configured to execute the computer program to:
acquire a data volume of metadata of each type;
allocate a corresponding quantity of CPUs to the metadata of each type according to the data volume of metadata of each type; and
when the storage device is powered on, control each CPU to recover the metadata of the type corresponding to each CPU.

21. The data recovery method according to claim 4, wherein the CPUs allocated to the metadata of the type with the data volume greater than the preset data volume has a faster processing speed than the CPUs allocated to the metadata of the type with the data volume not greater than the preset data volume.
